(19) United States
(12) Patent Application Publication
(10) Pub. No.: US 2024/0029575 A1
(43) Pub. Date: Jan. 25, 2024

(54) METHOD AND APPARATUS FOR CONTROLLING OPERATIONS OF FLIGHT VEHICLES

(71) Applicant: PABLO AIR Co., Ltd., Incheon (KR)

(72) Inventors: Hyeong Min KIM, Incheon (KR); Seung Han LIM, Daejeon (KR); Youngjoon KIM, Incheon (KR); Seung Yeop LEE, Incheon (KR); Hyun Woo LEE, Incheon (KR)

(73) Assignee: PABLO AIR Co., Ltd., Incheon (KR)

(21) Appl. No.: 18/355,474

(22) Filed: Jul. 20, 2023

(30) Foreign Application Priority Data
Jul. 25, 2022 (KR) 10-2022-0091858

(51) Int. Cl. G08G 5/04; G08G 5/00

(52) U.S. Cl. CPC G08G 5/045; G08G 5/0021; G08G 5/0078

(57) ABSTRACT

A method of controlling the operations of flight vehicles is provided. The method may comprise assigning neighboring virtual flight vehicles to each of monitored flight vehicles, inputting operation information of the monitored flight vehicles to a collision detection model, and if information indicating that a collision has occurred between neighboring virtual flight vehicles of the first monitored flight vehicle and neighboring virtual flight vehicles of the second monitored flight vehicle is output from the collision detection model, outputting a collision warning message, wherein the collision detection model is a model that utilizes operation information of the neighboring virtual flight vehicles, which is obtained by applying the operation information of the monitored flight vehicles to their respective neighboring virtual flight vehicles, to determine and output the occurrence of a collision between the neighboring virtual flight vehicles of the first and second monitored flight vehicles.

### CROSS-REFERENCE TO RELATED APPLICATION

This application claims priority from Korean Patent Application No. 10-2022-0091858 filed on Jul. 25, 2022, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and apparatus for controlling the operations of flight vehicles, and more particularly, to a method and apparatus for controlling the operations of flight vehicles when a potential collision between the flight vehicles is detected.

### 2. Description of the Related Art

A method of controlling the operations of flight vehicles, capable of avoiding a collision between the flight vehicles, is presented. Controllers utilize a control screen with operation information of a plurality of flight vehicles to assess the operational states of the flight vehicles and take appropriate actions to control their operations based on prevailing circumstances.

For example, controllers employ information gathered from sensors installed in each monitored flight vehicle to anticipate and notify the pilots, via communication, about potential collision risks between the monitored flight vehicles to avert collisions among the monitored flight vehicles.

However, if the sensors malfunction or if there is inadequate communication between the controllers and the pilots of the monitored flight vehicles, it becomes challenging to accurately predict and caution against collision risks, thereby impeding effective collision prevention measures between the monitored flight vehicles.

### SUMMARY

Aspects of the present disclosure provide a method and apparatus for controlling the operations of flight vehicles, which enable the display of multiple control screens, where operation information of a plurality of monitored flight vehicles is displayed, and allow a user to easily identify various information related to the operations of the monitored flight vehicles.

Aspects of the present disclosure also provide a method and apparatus for controlling the operations of flight vehicles, which can accurately predict the risk of collisions between the monitored flight vehicles via a plurality of control screens and a collision prediction model that utilizes augmented reality (AR) images.

Aspects of the present disclosure also provide a method and apparatus for controlling the operations of flight vehicles, which can promptly and efficiently notify a controller of any detected collisions between the monitored flight vehicles through a control screen.

Aspects of the present disclosure also provide a method and apparatus for controlling the operations of flight vehicles, which prevent collisions between the monitored flight vehicles by providing a control screen displaying selectable collision avoidance alternatives.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the inventive concept, there is a method of controlling the operations of flight vehicles, performed by a computing device. The method may comprise assigning neighboring virtual flight vehicles to each of monitored flight vehicles, inputting operation information of the monitored flight vehicles to a collision detection model, and if information indicating that a collision has occurred between neighboring virtual flight vehicles of the first monitored flight vehicle and neighboring virtual flight vehicles of the second monitored flight vehicle is output from the collision detection model, outputting a collision warning message, wherein the collision detection model may be a model that utilizes operation information of the neighboring virtual flight vehicles, which is obtained by applying the operation information of the monitored flight vehicles to their respective neighboring virtual flight vehicles, to determine and output the occurrence of a collision between the neighboring virtual flight vehicles of the first and second monitored flight vehicles.

In some embodiments, assigning the neighboring virtual flight vehicles to each of the monitored flight vehicles may comprise providing a first control screen that displays the operation information of the monitored flight vehicles and providing a second control screen that displays operation information of neighboring virtual flight vehicles of the second monitored flight vehicle, obtained using a camera installed in the first monitored flight vehicle.

In some embodiments, the neighboring virtual flight vehicles may have the same shape and specifications as their respective monitored flight vehicles.

In some embodiments, outputting the collision warning message may comprise predicting a potential collision between the first and second monitored flight vehicles, displaying context information of the potential collision on the first control screen if the potential collision is predicted, and displaying details on how to control the first and second monitored flight vehicles to avoid the potential collision on the first control screen.

In some embodiments, predicting the potential collision between the first and second monitored flight vehicles may comprise predicting that a collision between the first and second monitored flight vehicles will occur when a collision between one of the neighboring virtual flight vehicles of the first monitored flight vehicle and one of the neighboring virtual flight vehicles of the second monitored flight vehicle occurs.

In some embodiments, displaying the context information of the potential collision on the first control screen may comprise displaying a collision warning message for the potential collision, information of monitored flight vehicles associated with the potential collision, and location information of the potential collision on the first control screen, and displaying operation information of the monitored flight vehicles associated with the potential collision and operation information of their respective neighboring virtual flight vehicles on the first control screen in response to predefined user input for the first control screen.

In some embodiments, displaying the operation of the monitored flight vehicles associated with the potential collision and operation information of their respective neighboring virtual flight vehicles may comprise displaying the first and second monitored flight vehicles in a visually distinguishable manner from the other monitored flight vehicles and displaying operation information of the first monitored flight vehicle and operation of the second monitored flight vehicle around the first and second monitored flight vehicles, respectively.

In some embodiments, displaying the details on how to control the first and second monitored flight vehicles may comprise displaying the neighboring virtual flight vehicles of the first monitored flight vehicle and the neighboring virtual flight vehicles of the second monitored flight vehicle and displaying guidelines for avoiding the potential collision between the first and second monitored flight vehicles.

In some embodiments, displaying the guidelines for avoiding the potential collision between the first and second monitored flight vehicles may comprise displaying guidelines for deviating the first monitored flight vehicle from a predefined flight path of the first monitored flight vehicle.

In some embodiments, displaying the guidelines for avoiding the potential collision between the first and second monitored flight vehicles may comprise displaying guidelines for deviating the second monitored flight vehicle from a predefined flight path of the second monitored flight vehicle.

In some embodiments, displaying the guidelines for avoiding the potential collision between the first and second monitored flight vehicles may further comprise avoiding the potential collision between the first and second monitored flight vehicles by automatically selecting one of the guidelines if no user input is received for a predefined amount of time after the displaying the guidelines for avoiding the potential collision between the first and second monitored flight vehicles.

According to yet another aspect of the inventive concept, there is a provided computer system for controlling the operations of flight vehicles. The system may comprise at least one processor and at least one memory configured to store instructions, wherein the instructions, when executed by at least one processor, causes the at least one processor to perform assigning neighboring virtual flight vehicles to each of monitored flight vehicles, inputting operation information of the monitored flight vehicles to a collision detection model, and if information indicating that a collision has occurred between neighboring virtual flight vehicles of the first monitored flight vehicle and neighboring virtual flight vehicles of the second monitored flight vehicle is output from the collision detection model, outputting a collision warning message, and the collision detection model is a model that utilizes operation information of the neighboring virtual flight vehicles, which is obtained by applying the operation information of the monitored flight vehicles to their respective neighboring virtual flight vehicles, to determine and output the occurrence of a collision between the neighboring virtual flight vehicles of the first and second monitored flight vehicles.

In some embodiments, the operation of assigning the neighboring virtual flight vehicles to each of the monitored flight vehicles may comprise providing a first control screen that displays the operation information of the monitored flight vehicles and providing a second control screen that displays operation information of neighboring virtual flight vehicles of the second monitored flight vehicle, obtained using a camera installed in the first monitored flight vehicle.

In some embodiments, the neighboring virtual flight vehicles may have the same shape and specifications as their respective monitored flight vehicles.

In some embodiments, the operation of outputting the collision warning message may comprise predicting a potential collision between the first and second monitored flight vehicles, displaying context information of the potential collision on the first control screen if the potential collision is predicted, and displaying details on how to control the first and second monitored flight vehicles to avoid the potential collision on the first control screen.

In some embodiments, the operation of predicting the potential collision between the first and second monitored flight vehicles may comprise predicting that a collision between the first and second monitored flight vehicles will occur when a collision between one of the neighboring virtual flight vehicles of the first monitored flight vehicle and one of the neighboring virtual flight vehicles of the second monitored flight vehicle occurs.

In some embodiments, the operation of displaying the details on how to control the first and second monitored flight vehicles may comprise displaying the neighboring virtual flight vehicles of the first monitored flight vehicle and the neighboring virtual flight vehicles of the second monitored flight vehicle and displaying guidelines for avoiding the potential collision between the first and second monitored flight vehicles.

In some embodiments, the operation of displaying the guidelines for avoiding the potential collision between the first and second monitored flight vehicles may comprise displaying guidelines for deviating the first monitored flight vehicle from a predefined flight path of the first monitored flight vehicle.

In some embodiments, the operation of displaying the guidelines for avoiding the potential collision between the first and second monitored flight vehicles may comprise displaying guidelines for deviating the second monitored flight vehicle from a predefined flight path of the second monitored flight vehicle.

In some embodiments, the operation of displaying the guidelines for avoiding the potential collision between the first and second monitored flight vehicles may further comprise avoiding the potential collision between the first and second monitored flight vehicles by automatically selecting one of the guidelines if no user input is received for a predefined amount of time after the displaying the guidelines for avoiding the potential collision between the first and second monitored flight vehicles.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a flowchart illustrating a method of controlling the operations of flight vehicles according to an embodiment of the present disclosure;

FIG. 2 is a detailed flowchart illustrating “S100” of FIG. 1;

FIGS. 3 and 4 illustrate a plurality of control screens displaying operation information of flight vehicles, which can be referenced in some embodiments of the present disclosure;

FIG. 5 illustrates a method of arranging neighboring virtual flight vehicles, which can be referenced in some embodiments of the present disclosure;

FIG. 6 is a detailed flowchart illustrating “S300” of FIG. 1;

FIG. 7 illustrates an exemplary screen displaying neighboring virtual flight vehicles, which can be referenced in some embodiments of the present disclosure;

FIG. 8 illustrates a method of determining a potential collision between flight vehicles, which can be referenced in some embodiments of the present disclosure;

FIG. 9 is a detailed flowchart illustrating “S320” of FIG. 6;

FIG. 10 illustrates some of the processes depicted in FIG. 9;

FIG. 11 is a detailed flowchart illustrating “S322” of FIG. 9;

FIG. 12 illustrates some of the processes depicted in FIG. 11;

FIG. 13 is a detailed flowchart illustrating “S330” of FIG. 6;

FIG. 14 illustrates some of the processes depicted in FIG. 13; and

FIG. 15 is a hardware configuration view of a system for providing flight vehicle operation information in accordance with some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In describing the present disclosure, when it is determined that the detailed description of the related well-known configuration or function may obscure the gist of the present disclosure, the detailed description thereof will be omitted.

In addition, in describing the component of this disclosure, terms, such as first, second, A, B, (a), (b), can be used. These terms are only for distinguishing the components from other components, and the nature or order of the components is not limited by the terms.

Hereinafter, embodiments of the present disclosure are described with reference to the accompanying drawings.

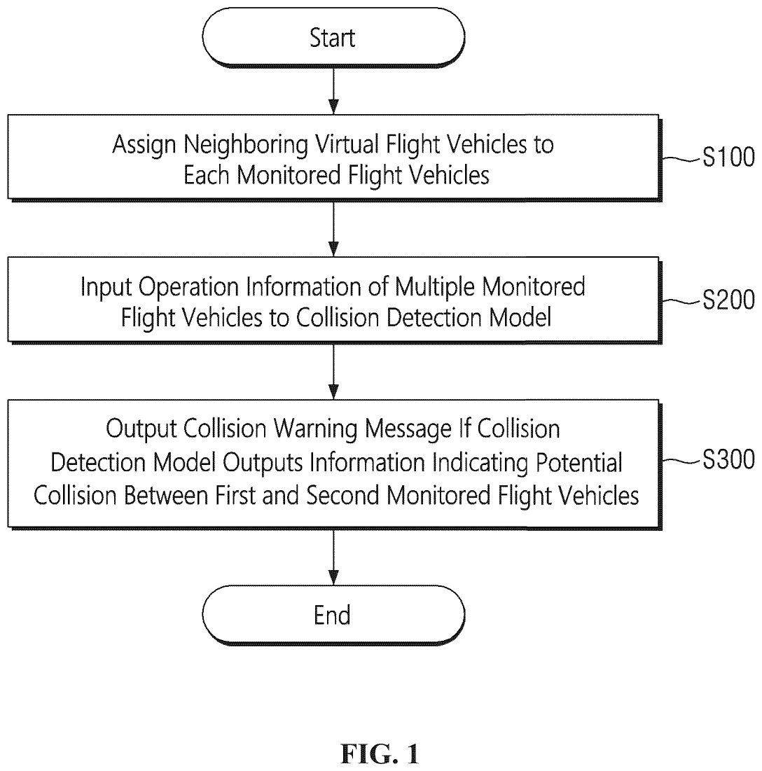

FIG. 1 is a flowchart illustrating a method of controlling the operations of flight vehicles according to an embodiment of the present disclosure. It is noted that the method depicted in FIG. 1 serves as an illustrative example, and it is possible to include additional steps in or remove certain steps from the method of FIG. 1.

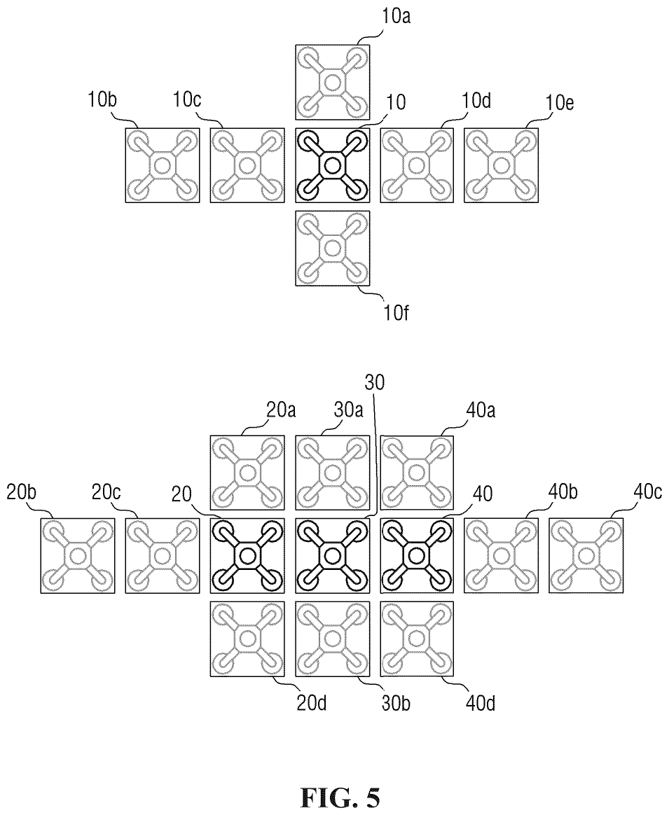

Referring to FIG. 1, in S100, neighboring virtual flight vehicles are assigned to each monitored flight vehicle. A predefined number of neighboring virtual flight vehicles may be arranged in a predefined layout around each monitored flight vehicle, and this will be described later with reference to FIG. 5.

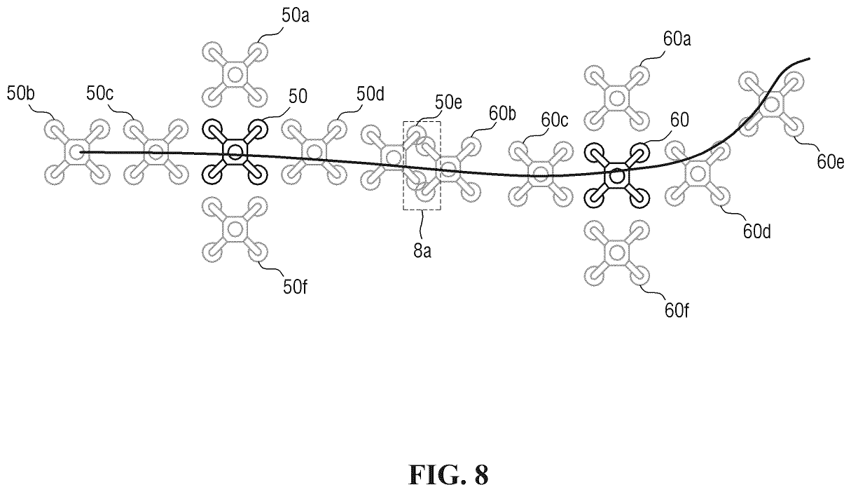

In S200, operation information of a plurality of monitored flight vehicles may be input to a collision detection model. The collision detection model may be a model that determines and outputs the occurrence of collisions between neighboring virtual flight vehicles of each of the monitored flight vehicles based on operation information of the neighboring virtual flight vehicles, which is generated using the operation information of the monitored flight vehicles. The speed and direction of movement of the neighboring virtual flight vehicles may be the same as those of their respective monitored flight vehicles. A method of predicting a potential collision between the monitored flight vehicles via the collision detection model will be described later with reference to FIG. 8.

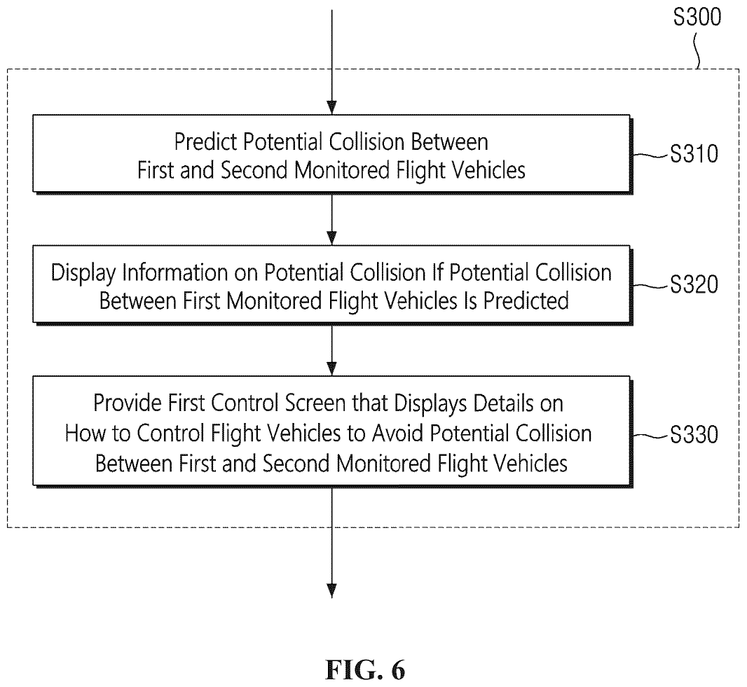

In S300, if the collision detection model outputs information indicating a potential collision between a neighboring virtual flight vehicle of a first monitored flight vehicle and a neighboring virtual flight vehicle of a second monitored flight vehicle, a collision warning message may be output. Specifically, the collision warning message may include context information of the potential collision between the first and second monitored flight vehicles and details on how to control the first and second monitored flight vehicles to avoid the collision. This will be described later with reference to FIGS. 6 through 14.

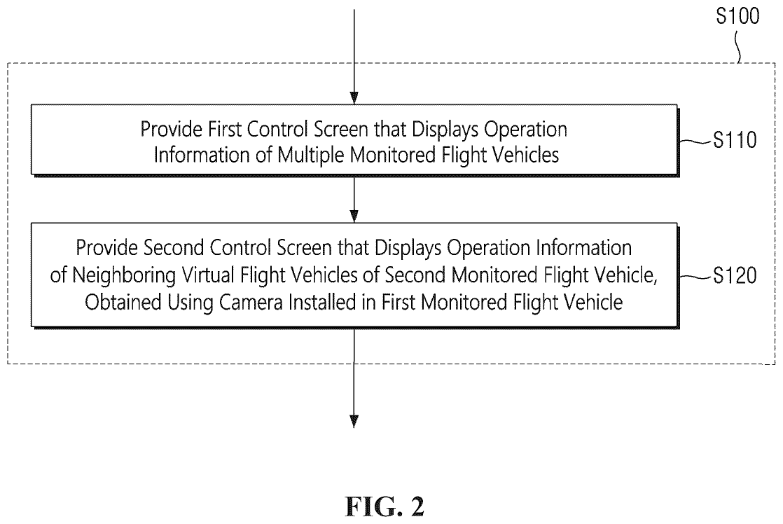

First and second control screens where the operation information of the monitored target vehicles is displayed will hereinafter be described with reference to FIGS. 2 through 4.

FIG. 2 is a detailed flowchart illustrating “S100” of FIG. 1. It is noted that the method depicted in FIG. 1 serves as an illustrative example, and it is possible to include additional steps in or remove certain steps from S100 of FIG. 1.

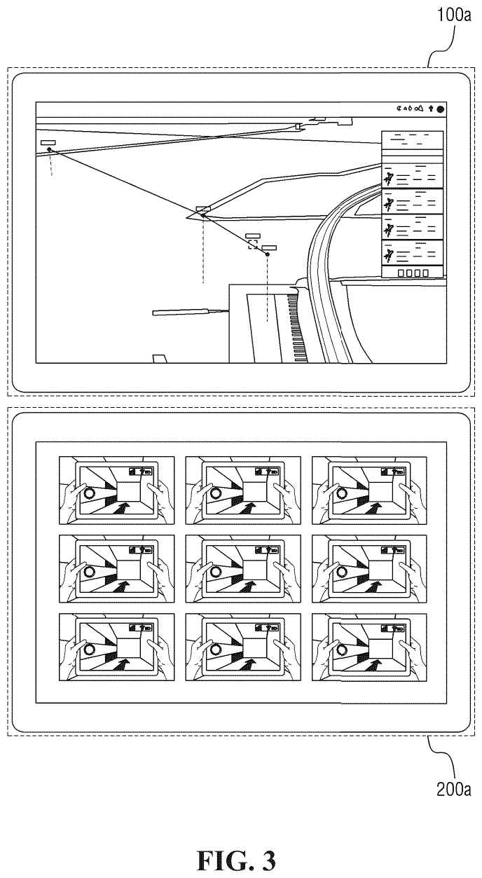

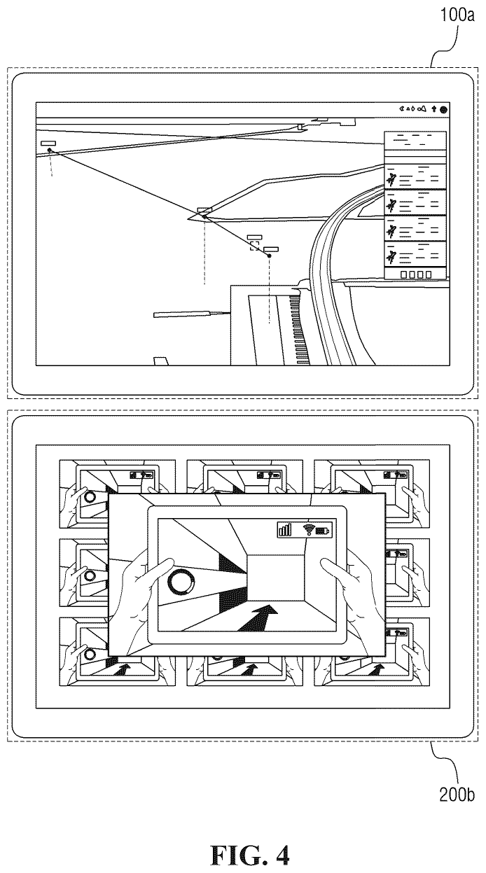

Referring to FIG. 2, S100, which is the step of assigning neighboring virtual flight vehicles to each of the first and second monitored flight vehicles, may include the following sub-steps: S110, which involves providing a first control screen that displays the operation information of the first monitored flight vehicles; and S120, which provides a second control screen that displays operation information of neighboring virtual flight vehicles of the second monitored flight vehicle, which is obtained using a camera installed in the first monitored flight vehicle. S110 and S120 will hereinafter be described with reference to FIGS. 3 and 4.

FIGS. 3 and 4 illustrate a plurality of control screens displaying operation information

of flight vehicles, which can be referenced in some embodiments of the present disclosure.

Multiple control screens that can be provided before the detection of a potential collision between the monitored flight vehicles will hereinafter be described with reference to FIG. 3.

Referring to FIG. 3, a first control screen 100a where the operation information of the monitored flight vehicles is displayed may be provided. The operation information of the monitored flight vehicles, displayed on the first control screen 100a, may include route information from the departures to the destinations of the monitored flight vehicles, real-time speed information of the monitored flight vehicles, and real-time surrounding geographical information of the locations of the monitored flight vehicles are currently situated. When a potential collision between the monitored flight vehicles is detected, a first control screen with collision information may be provided.

A second control screen 200a, which displays operation information of neighboring virtual flight vehicles of the second monitored flight vehicle, obtained using the camera installed in the first monitored flight vehicle, may be provided together with the first control screen 100a. Specifically, augmented reality (AR) images captured using the cameras installed in the monitored flight vehicles may be presented on the second control screen 200a. AR technologies are widely recognized in the field to which the present disclosure pertains, and therefore, detailed descriptions thereof will be omitted.

Multiple control screens that can be provided after the detection of a potential collision between the monitored flight vehicles will hereinafter be described with reference to FIG. 4.

Referring to FIG. 4, when a potential collision between the monitored flight vehicles is detected by the collision detection model, a second control screen 200B displaying an enlarged image of an AR image captured using the camera installed in one of the monitored flight vehicles involved in the detected potential collision may be provided. Here, the AR image may be an image captured by the camera installed in one of first and second monitored flight vehicles that are involved in the detected potential collision. The AR image may have a playback time that corresponds to a predefined length and may be updated at intervals of a predetermined amount of time.

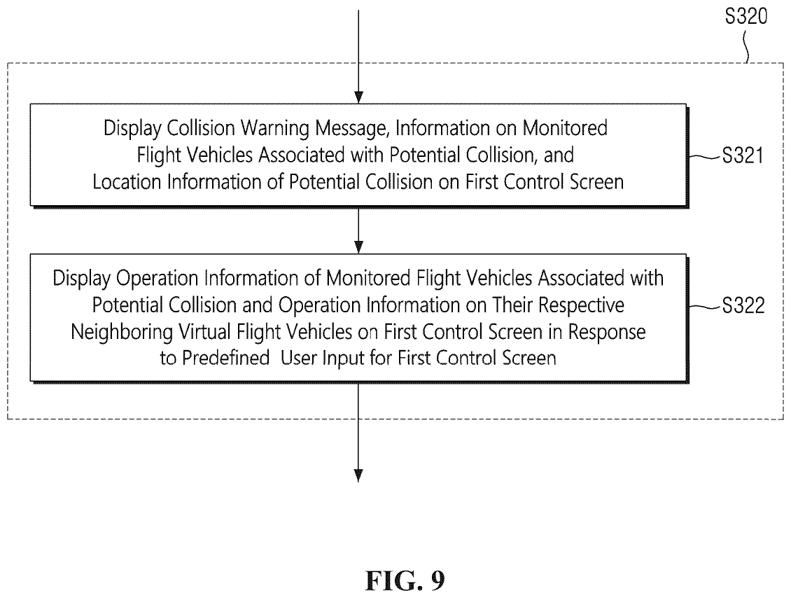

A first control screen that can be provided after the detection of a potential collision will be described later with reference to FIGS. 9 through 14. FIGS. 3 and 4 illustrate that the first and second control screens 100a and 200a (or 200b) are arranged side-by-side vertically. However, alternatively, the first and second control screens 100a and 200a (or 200b) may be arranged side-by-side horizontally.

A user or controller can recognize the operating statuses of the monitored flight vehicles based on the operation information presented on a single control screen, and can control the monitored flight vehicles individually depending on the circumstances. However, this method has limitations, especially when there is a large number of monitored flight vehicles.

According to the embodiment of FIGS. 3 and 4, as the first control screen that displays real-time operation information of the monitored flight vehicles and the second control screen that displays operation information of neighboring virtual flight vehicles assigned to each of the monitored flight vehicles are both provided, the user can easily recognize the operating statuses of the monitored flight vehicles. Furthermore, as an image of a simulated collision between the neighboring virtual flight vehicles is presented on the second control screen, the visual effect of a warning against potential collisions between the monitored flight vehicles can be maximized. As a result, efficient control of the monitored flight vehicles' operations can be achieved by facilitating the identification of their operation information, ensuring safety by preventing potential collisions.

A first computing device (not illustrated) that outputs the first and second control screens 100a and 200a may transmit the operation information of the monitored flight vehicles to the collision detection model.

The collision detection model may predict potential collisions between the monitored flight vehicles based on the operation information of the neighboring virtual flight vehicles, presented on the second control screen 200a. If a potential collision between the monitored flight vehicles is predicted, an enlarged image of an AR image captured from one of the monitored flight vehicles that are involved in the potential collision may be presented on the second control screen 200b.

Also, the collision detection model may transmit information on the predicted potential collision to the first computing device, and the first computing device may output an updated first control screen 100b or 100c and an updated second control screen 200b that presents the information on the predicted potential collision. This will be described later with reference to FIGS. 8 through 13.

A computing device that outputs the second control screen 200a or 200b may be a second computing device (not illustrated), which differs from the first computing device. In the following description, the first computing device is assumed to be responsible for outputting the first control screen 100a, 100b, or 100c and the second control screen 200a or 200b is the first computing device.

In summary, a conventional method of predicting and issuing warnings for potential collisions between multiple monitored flight vehicles, based solely on operation information for a current time point, faces spatial limitations when attempting to efficiently display various related information, such as operation information, potential collision information, and collision warning messages, on a single control screen. However, by providing the user with both the first control screen that displays the operation information of the multiple monitored flight vehicles and the second control screen that displays the operation information of the neighboring virtual flight vehicles of each of the multiple monitored flight vehicles, it becomes possible to efficiently present various flight operation information.

A method of displaying virtual flight vehicles around each monitored flight vehicle will hereinafter be described with reference to FIG. 5.

FIG. 5 illustrates a method of arranging neighboring virtual flight vehicles, which can be referenced in some embodiments of the present disclosure.

Referring to FIG. 5, neighboring virtual flight vehicles 10a through 10f may be displayed around a monitored flight vehicle 10. The neighboring virtual flight vehicles 10a through 10f may have the same shape and specifications as the monitored flight vehicle 10. Specifically, two virtual flight vehicles 10d and 10e may be displayed at the front of the monitored flight vehicle 10, two virtual flight vehicles 10b and 10c may be displayed at the rear of the monitored flight vehicle 10, and one virtual flight vehicle 10a or 10f may be displayed on the side of the monitored flight vehicle 10.

According to the embodiment of FIG. 5, virtual flight vehicles may be displayed around each monitored flight vehicle, instead of safety ranges. In the event of a predicted potential collision, an image of a simulated collision between the neighboring virtual flight vehicles can be presented, thereby enhancing the visual warning effect and enabling the user to quickly and adaptively respond to the potential collision.

If multiple monitored flight vehicles 20, 30, and 40 are flying in formation, their corresponding neighboring virtual flight vehicles may also be displayed around each monitored flight vehicle. Specifically, virtual flight vehicles 20a through 20c, 30a and 30b, and 40a through may be displayed around the monitored flight vehicles 20, 30, and 40, respectively. If the monitored flight vehicles 20, 30, and 40 share the same shape, the neighboring virtual flight vehicles 20a through 20c, 30a and 30b, and 40a through 40d may also be presented in the same shape. Conversely, if the monitored flight vehicles 20, 30, and 40 have different shapes, at least some of the neighboring virtual flight vehicles 20a through 20c, 30a and 30b, and 40a through 40d may have different shapes as well.

However, the arrangement method of neighboring virtual flight vehicles assigned to the neighboring area of each monitored flight vehicle is not limited to that illustrated in FIG. 5 and can be determined by the user using various other methods. For example, in the case of a flight vehicle carrying hazardous materials sensitive to collisions, safety can be ensured by increasing the number of neighboring virtual flight vehicles assigned to the flight vehicle or changing the pattern of arrangement of the neighboring virtual flight vehicles. Furthermore, when multiple flight vehicles fly in formation, a greater number of neighboring virtual flight vehicles can be placed on the left and right sides of each monitored flight vehicles compared to other sides, thereby enhancing safety.

Meanwhile, monitored flight vehicles involved in a potential collision, along with their respective neighboring virtual flight vehicles, may be differentiated from other monitored flight vehicles or neighboring virtual flight vehicles by being displayed with a distinguishable feature such as a red border, as illustrated in FIG. 5.

FIG. 6 is a detailed flowchart illustrating “S300” of FIG. 1. It is noted that the method depicted in FIG. 1 serves as an illustrative example, and it is possible to include additional steps in or remove certain steps from S300 of FIG. 1.

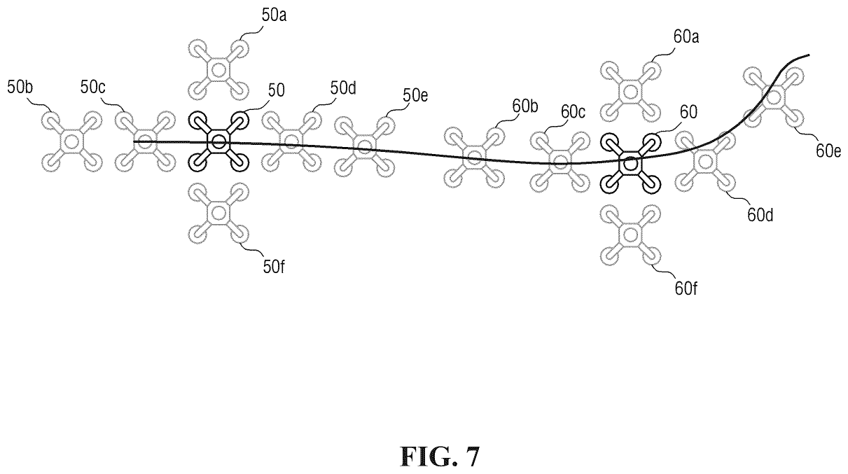

Referring to FIG. 6, S300, which is the step of outputting a collision warning message, may include the following sub-steps: S310, which involves predicting a potential collision between the first and second monitored flight vehicles; S320, which involves displaying context information of the potential collision on the first control screen if the potential collision is predicted; and S330, which involves presenting details on how to control the first and second monitored flight vehicles to avoid the potential collision on the first control screen. The embodiment of FIG. 6 will hereinafter be described with reference to FIGS. 7 through 14.

First, S310 of FIG. 6 will hereinafter be described with reference to FIGS. 7 and 8.

FIG. 7 illustrates an exemplary screen displaying neighboring virtual flight vehicles, which can be referenced in some embodiments of the present disclosure. Specifically, FIG. 7 illustrates an exemplary screen provided prior to a collision occurring between neighboring virtual flight vehicles of the first and second monitored flight vehicles.

Referring to FIG. 7, neighboring virtual flight vehicles 50a through 50f may be displayed around a first monitored flight vehicle 50, and neighboring virtual flight vehicles 60a through 60f may be displayed around a second monitored flight vehicle 60. When an image of the second monitored flight vehicle 60 is captured by a camera installed in the first monitored flight vehicle 50, the neighboring virtual flight vehicles 60a through 60f may be displayed around the second monitored flight vehicle 60. Alternatively, when the distance between the first and second monitored flight vehicles 50 and 60 is less than a reference value, the neighboring virtual flight vehicles 60a through 60f may be displayed around the second monitored flight vehicle 60.

The neighboring virtual flight vehicle 50e may be the closest neighboring virtual flight vehicle to the first monitored flight vehicle 50, and the neighboring virtual flight vehicle 60b may be the closest neighboring virtual flight vehicle to the second monitored flight vehicle 60.

FIG. 8 illustrates a method of determining a potential collision between flight vehicles, which can be referenced in some embodiments of the present disclosure. Specifically, FIG. 8 depicts the situation after a collision has occurred between neighboring virtual flight vehicles, while FIG. 7 represents the situation prior to the collision. As a result, redundant explanations that cover the content already described with reference to FIG. 7 will be omitted.

Referring to FIG. 8, a collision 8a may potentially occur between the neighboring virtual flight vehicle 50e of the first monitored flight vehicle 50 and the neighboring virtual flight vehicle 60b of the second monitored flight vehicle 60. When the collision 8a occurs, the collision detection model may identify a potential risk of a collision between the first and second monitored flight vehicles 50 and 60 colliding with each other. In this case, the first control screen may be presented, displaying context information of the collision 8a and providing guidance on how to control the first and second monitored flight vehicles 50 and 60 to avoid the collision 8a.

That is, if a collision occurs between the neighboring virtual flight vehicles of the monitored flight vehicles, the collision detection model may predict that a collision will occur soon between the monitored flight vehicles.

The first and second monitored flight vehicles 50 and 60, along with the neighboring virtual flight vehicles 50a through 50f and 60a through 60f may be highlighted with a red border and may thus be able to be visually distinguished from other monitored flight vehicles (not illustrated) that are not associated with the predicted potential collision.

To summarize, when a collision between the neighboring virtual flight vehicles of the monitored flight vehicles occurs, a potential collision between the monitored flight vehicles can be predicted, and the visual warning effect can be maximized, thereby preventing the collision. Furthermore, utilizing AR images captured by cameras instead of Light Detection and Ranging (LiDAR) or Radio Detection and Ranging (RaDAR) sensors can enhance both efficiency and cost-effectiveness.

A method of presenting context information of a detected potential collision between the monitored flight vehicles on the first control screen will hereinafter be described with reference to FIGS. 9 through 12. The presentation of the context information of the detected potential collision on the first control screen may be performed by the computing device (not illustrated) that displays the first and second control screens. The first control screen may be the first control screen 100a described above with reference to FIGS. 1 through 8, and the second control screen may be the second control screen 200a or 200b described above with reference to FIGS. 1 through 8. The technical concept of the embodiments of FIGS. 1 through 8 may be directly applicable to the embodiment of FIGS. 9 through 12.

FIG. 9 is a detailed flowchart illustrating “S320” of FIG. 6. Specifically, FIG. 9 is a flowchart illustrating the processes to be performed when the collision detection model detects a potential collision between the monitored flight vehicles.

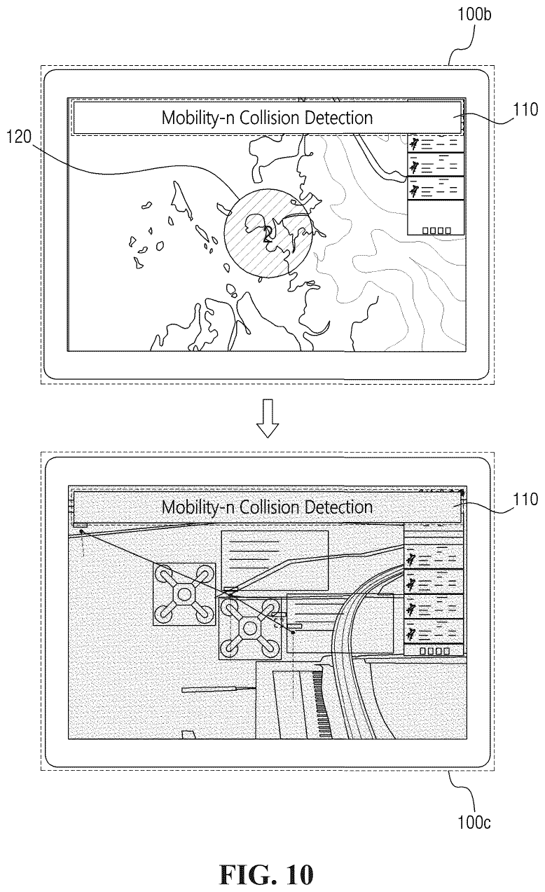

Referring to FIG. 9, S320, which is the step of displaying the context information of the potential collision between the first and second monitored flight vehicles on the first control screen, may include the following sub-steps: S321, which involves presenting information on the monitored flight vehicles associated with the potential collision and location information of the potential collision on the first control screen; and S322, which involves displaying operation information of the monitored flight vehicles associated with the potential collision and operation information of their respective neighboring virtual flight vehicles on the first control screen in response to predefined user input for the first control screen. S320 of FIG. 9 will hereinafter be described in further detail with reference to FIG. 10.

Specifically, it will hereinafter be described how to display a collision warning message and location information on a potential collision between the monitored flight vehicles on the first control screen when the potential collision is detected.

FIG. 10 illustrates some of the processes depicted in FIG. 9.

Referring to FIG. 10, a collision warning message 110 may be displayed on the first control screen 100b, and collision information 120, including location information regarding a detected potential collision and information on monitored flight vehicles involved in the detected potential collision, may also be displayed. The collision warning message 110 may have a red border and a distinctive background color. The collision information 120 may be displayed within a red circle to ensure visual differentiation. Furthermore, the number of monitored flight vehicles associated with the detected potential collision may also be displayed within the red circle.

However, the present disclosure is not limited to the example of FIG. 10. That is, the visual presentation of various information regarding the detected potential collision can take different forms other than the one depicted in FIG. 10 as long as it enables the controller or user to easily and quickly comprehend the detected potential collision.

For example, the collision warning message 110 and the collision information 120 may be displayed to flash in red for a predetermined amount of time.

A method of displaying operation information of monitored flight vehicles associated with a potential collision and operation information of their respective neighboring virtual flight vehicles on the first control screen will hereinafter be described.

Referring again to FIG. 10, in response to predefined user input for the first control screen 100b, operation information of monitored flight vehicles associated with a predicted potential collision and operation information of their respective neighboring virtual flight vehicles may be displayed on the first control screen 100b. Specifically, in response to predefined user input for the first control screen 100b, the location of the predicted potential collision may be visually magnified and displayed, and the monitored flight vehicles associated with the predicted potential collision may be visually highlighted with a red border, and a first control screen 100c that flashes with a red background for a predetermined period of time may be provided. The predefined user input may be a touch input, a mouse click, or a scroll input on the collision information 120, which includes information on the monitored flight vehicles associated with the predicted potential collision and the location information of the predicted potential collision.

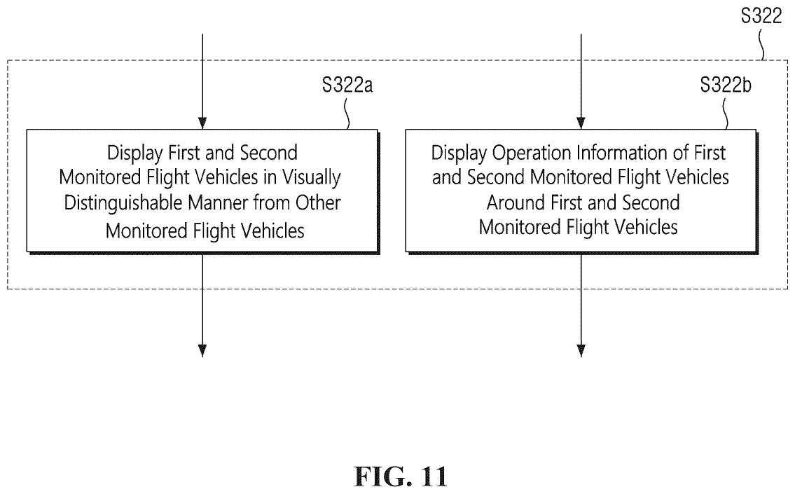

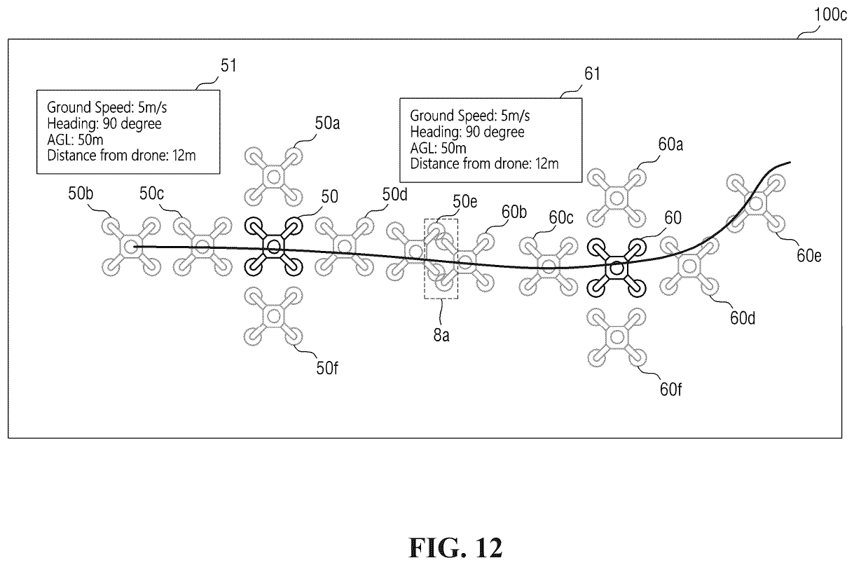

A first control screen displaying operation information of monitored flight vehicles associated with a predicted potential collision and operation information of their respective neighboring virtual flight vehicles will hereinafter be described with reference to FIGS. 11 and 12.

FIG. 11 is a detailed flowchart illustrating “S322” of FIG. 9. It is noted that the method depicted in FIG. 1 serves as an illustrative example, and it is possible to include additional steps in or remove certain steps from S322 of FIG. 11.

Referring to FIG. 11, S322, which is the step of displaying operation information of the monitored flight vehicles associated with a potential collision and the operation information of their respective neighboring virtual flight vehicles on the first control screen in response to predefined user input for the first control screen, may include the following sub-steps: S322a, which involves displaying the first and second monitored flight vehicles in a visually distinguishable manner from the other monitored flight vehicles; and S322b, which involves displaying the operation information of the first and second monitored flight vehicles near the first and second monitored flight vehicles.

FIG. 12 illustrates some of the processes depicted in FIG. 11. Specifically, FIG. 12 illustrates a method of providing a first control screen that displays operation information of monitored flight vehicles associated with a predicted potential collision and operation information of their respective neighboring virtual flight vehicles.

Referring to FIG. 12, the first and second monitored flight vehicles 50 and 60, which are associated with a predicted potential collision, may be displayed in a visually distinguishable manner from the other monitored flight vehicles. For example, the first and second monitored flight vehicles 50 and 60 may be highlighted with a red border.

The neighboring virtual flight vehicles 50a through 50f may be displayed around the first monitored flight vehicle 50, and the neighboring virtual flight vehicles 60a through 60f may be displayed around the second monitored flight vehicle 60. The neighboring virtual flight vehicles 50a through 50f and 60a through 60f may also be displayed in a visually distinguishable manner from a third monitoring flight vehicle (not illustrated), which is not associated with the predicted potential collision, and neighboring virtual flight vehicles (not illustrated) of the third monitoring flight vehicle.

On the first control screen 100c, operation information 51 of the first monitoring flight vehicle 50 may be displayed near the first monitored flight vehicle 50, and operation information 61 of the second monitored flight vehicle 60 may be displayed near the second monitored flight vehicle 60.

The operation information 51 of the first monitored flight vehicle 50 and the operation information 61 of the second monitored flight vehicle 60 may include the ground speeds, headings, and above ground levels (AGLs) of the first and second monitored flight vehicles 50 and 60 and the distance between the first and second monitored flight vehicles 50 and 60.

When a potential collision between multiple monitored flight vehicles is detected, a first control screen can be provided to display information on the detected potential collision in various manners. This enables the user to receive prompt and efficient alerts regarding the detected potential collision, facilitating quick comprehension of the information and enabling the user to take appropriate actions in response to the detected potential collision.

Meanwhile, the user may face difficulty in easily identify potential collisions between multiple monitored flight vehicles across multiple screens. Thus, the collision detection model may promptly issue warnings for potential collisions by employing various methods, including sending vibrations or notifications to the user's smart device (such as a smartwatch or a mobile phone). Here, the user may be a controller or a pilot.

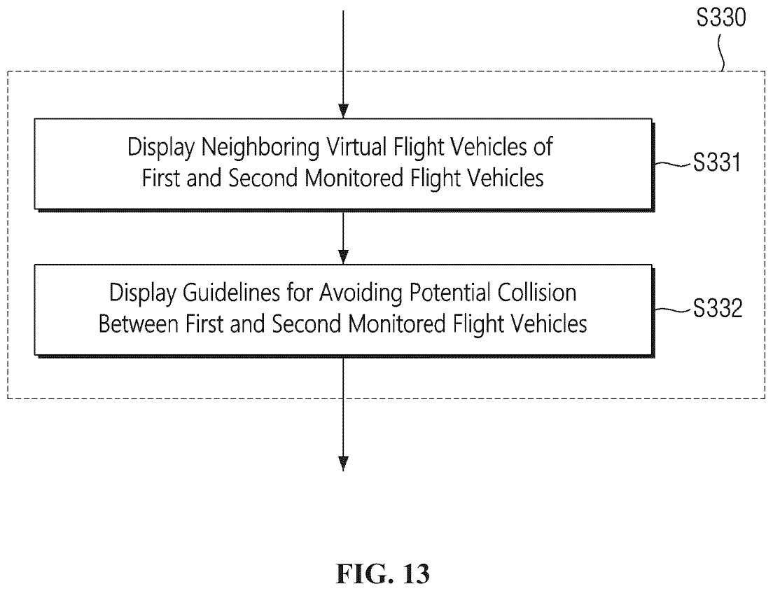

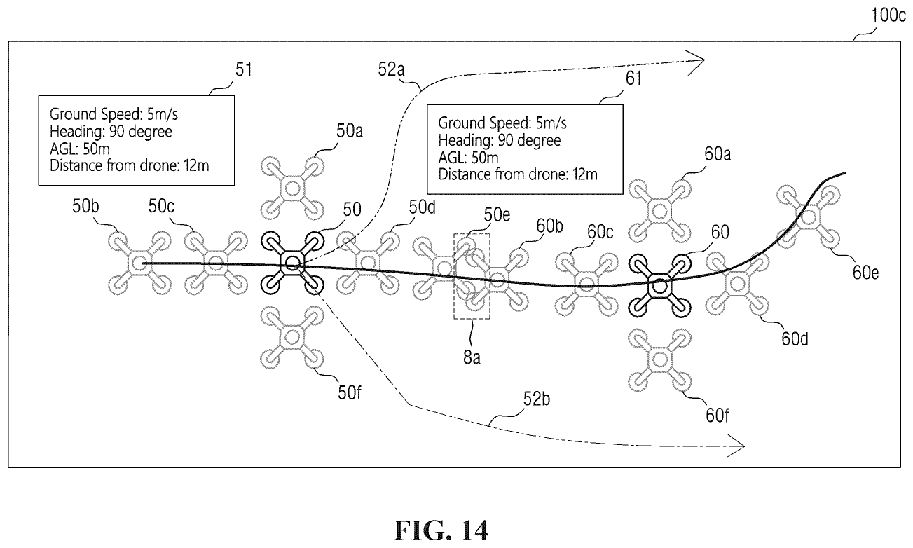

A method of avoiding collisions using operation information of a plurality of monitored flight vehicles according to an embodiment of the present disclosure will hereinafter be described with reference to FIGS. 13 and 14. The method of FIGS. 13 and 14 may be performed by a computing device (not illustrated) that outputs first and second control screens. The first control screen may be the first control screen 100a, 100b, or 100c, and the second control screen may be the second control screen 200a or 200b. The technical concept of the embodiment of FIGS. 1 through 12 may be directly applicable to the embodiment of FIGS. 13 and 14.

FIG. 13 is a detailed flowchart illustrating “S330” of FIG. 6. Specifically, FIG. 14 illustrates a method of providing a first control screen with guidelines for avoiding a detected potential collision between multiple flight vehicles, and it is noted that additional steps may be included in or certain steps may be removed from S330 of FIG. 13.

Referring to FIG. 13, S330, which is the step of displaying details on how to control the first and second monitored flight vehicles to avoid a potential collision, may include the following sub-steps: S331, which involves displaying the neighboring virtual flight vehicles of the first monitored flight vehicle and the neighboring virtual flight vehicles of the second monitored flight vehicle; and S332, which displays guidelines for avoiding the potential collision between the first and second monitored flight vehicles.

FIG. 14 illustrates some of the sub-steps depicted in FIG. 13. Specifically, FIG. 14 illustrates an exemplary first control screen with guidelines for avoiding the detected potential collision between the first and second monitored flight vehicles.

The operation information 51 of the first monitored flight vehicle 50 and the operation information 61 of the second monitored flight vehicle 60 are as described earlier with reference to FIG. 11, and thus, the embodiment of FIG. 14 will hereinafter be described, focusing mainly on guidelines 52a and 52b, which are displayed to avoid the potential collision between the first and second monitored flight vehicles 50 and 60.

Referring to FIG. 14, the first control screen 100c may be provided to display the guidelines 52a and 52b, which are for avoiding the potential collision between the first and second monitored flight vehicles 50 and 60. The guidelines 52a and 52b may be generated based on the operation information 51 of the first monitored flight vehicle 50 and the operation information 61 of the second monitored flight vehicle 60. In response to user input for the guidelines 52a and 52b, the potential collision between the first and second monitored flight vehicles 50 and 60 may be avoided by controlling at least one of the first and second monitored flight vehicles 50 and 60.

If no user input is received for a predefined duration, one of the guidelines 52a and 52b may be automatically selected to prevent the potential collision between the first and second monitored flight vehicles.

Although not specifically depicted in FIG. 14, the first and second monitored flight vehicles 50 and 60, which are associated with a potential collision, and the neighboring virtual flight vehicles 50a through 50f and 60a through 60f may be highlighted with, for example, a red border, as illustrated in FIG. 5, and may thus be able to be visually distinguished from the other monitored flight vehicles.

FIG. 14 illustrates an exemplary first control screen 100c with the guidelines 52a and 52b for controlling the first monitored flight vehicle 50, which is positioned relatively behind the second monitored flight vehicle 60, taking into account the routes of the first and second monitored flight vehicles 50 and 60 to prevent a potential collision between the first and second monitored flight vehicles. However, it is also possible to provide a first control screen 100c with guidelines (not illustrated) for controlling the second monitored flight vehicle 60 to avoid the potential collision between the first and second monitored flight vehicles 50 and 60.

Although the guidelines 52a and 52b for avoiding a collision between the first and second monitored flight vehicles 50 and 60 are presented in a two-dimensional (2D) plane, indicating potential control of either the first or second monitored flight vehicle 50 or 60 in horizontal and vertical directions to evade the collision, it is also feasible to provide a first control screen 100c with guidelines for controlling at least one of the speed, altitude, and heading of the first and second monitored flight vehicles 50 and 60 in a three-dimensional (3D) space for collision avoidance.

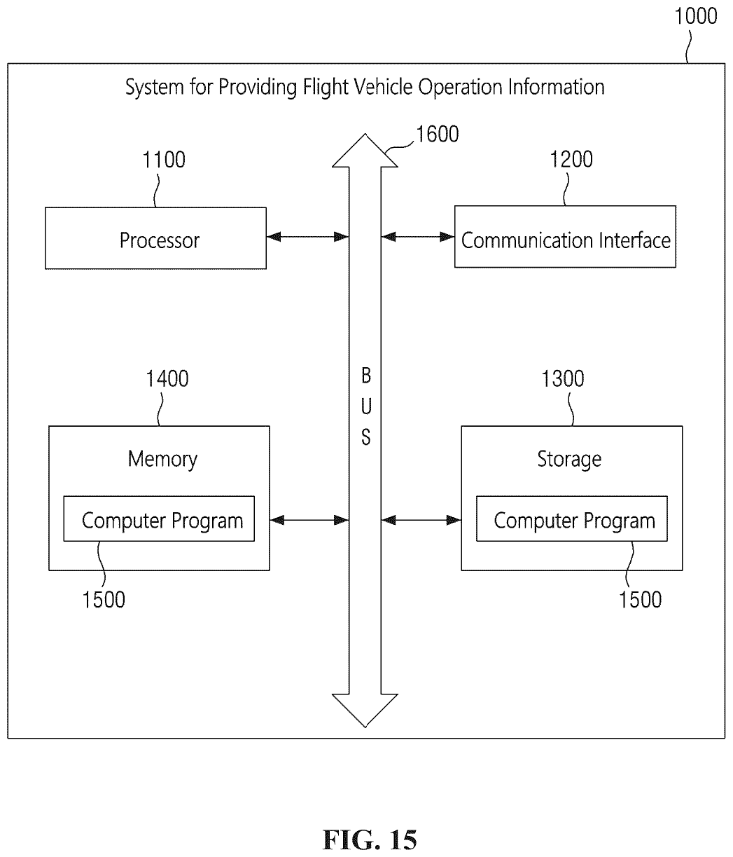

FIG. 15 is a hardware configuration view of a system for controlling the operations of flight vehicles in accordance with some embodiments of the present disclosure. Referring to FIG. 15, a system 1000 for controlling the operations of flight vehicles may include at least one processor 1100, a system bus 1600, a communication interface 1200, a memory 1400, which loads a computer program 1500 to be executed by the processor 1100, and a storage 1300, which stores the computer program 1500.

The processor 1100 controls the overall operation of the system 1000. The processor 1100 may perform computations for at least one application or program to execute methods/operations according to various embodiments of the present disclosure. The memory 1400 stores various data, commands, and/or information. The memory 1400 may load the computer program 1500 from the storage 1300 to execute the methods/operations according to various embodiments of the present disclosure. The system bus 1600 provides communication capabilities among the components of the system 1000. The communication interface 1200 supports Internet communication of the system 1000. The storage 1300 may temporarily store the computer program 1500. The computer program 1500 may include one or more instructions that implement the methods/operations according to various embodiments of the present disclosure. When the computer program 1500 is loaded into the memory 1400, the processor 1100 may perform the methods/operations according to various embodiments of the present disclosure by executing the one or more instructions.

In some embodiments, the system 1000 described with reference to FIG. 15 may be configured using cloud technologies, such as virtual machines, and leveraging one or more physical servers in a server farm. In this case, some of the components depicted in FIG. 15, such as the processor 1100, the memory 1400, and the storage 1300, may be implemented as virtual hardware. Similarly, the communication interface 1200 may be composed of virtualized networking elements, such as a virtual switch.

Embodiments of the present disclosure have been described above with reference to FIGS. 1 through 15, but it should be noted that the effects of the present disclosure are not limited to those described above, and other effects of the present disclosure should be apparent from the following description.

The technical features of the present disclosure described so far may be embodied as computer readable codes on a computer readable medium. The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation. The protection scope of the present invention should be interpreted by the following claims, and all technical ideas within the equivalent range should be interpreted as being included in the scope of the technical ideas defined by the present disclosure.

What is claimed is:

1. A method of controlling the operations of flight vehicles, performed by a computing device, comprising:
assigning neighboring virtual flight vehicles to each of monitored flight vehicles;
inputting operation information of the monitored flight vehicles to a collision detection model; and
if information indicating that a collision has occurred between neighboring virtual flight vehicles of the first monitored flight vehicle and neighboring virtual flight vehicles of the second monitored flight vehicle is output from the collision detection model, outputting a collision warning message,
wherein the collision detection model is a model that utilizes operation information of the neighboring virtual flight vehicles, which is obtained by applying the operation information of the monitored flight vehicles to their respective neighboring virtual flight vehicles, to determine and output the occurrence of a collision between the neighboring virtual flight vehicles of the first and second monitored flight vehicles.

2. The method of claim 1, wherein the assigning the neighboring virtual flight vehicles to each of the monitored flight vehicles, comprises providing a first control screen that displays the operation information of the monitored flight vehicles and providing a second control screen that displays operation information of neighboring virtual flight vehicles of the second monitored flight vehicle, obtained using a camera installed in the first monitored flight vehicle.

3. The method of claim 1, wherein the neighboring virtual flight vehicles have the same shape and specifications as their respective monitored flight vehicles.

4. The method of claim 1, wherein the outputting the collision warning message, comprises predicting a potential collision between the first and second monitored flight vehicles, displaying context information of the potential collision on the first control screen if the potential collision is predicted, and displaying details on how to control the first and second monitored flight vehicles to avoid the potential collision on the first control screen.

5. The method of claim 4, wherein the predicting the potential collision between the first and second monitored flight vehicles, comprises predicting that a collision between the first and second monitored flight vehicles will occur when a collision between one of the neighboring virtual flight vehicles of the first monitored flight vehicle and one of the neighboring virtual flight vehicles of the second monitored flight vehicle occurs.

6. The method of claim 4, wherein the displaying the context information of the potential collision on the first control screen, comprises displaying a collision warning message for the potential collision, information of monitored flight vehicles associated with the potential collision, and location information of the potential collision on the first control screen, and displaying operation information of the monitored flight vehicles associated with the potential collision and operation information of their respective neighboring virtual flight vehicles on the first control screen in response to predefined user input for the first control screen.

7. The method of claim 6, wherein the displaying the operation of the monitored flight vehicles associated with the potential collision and operation information of their respective neighboring virtual flight vehicles, comprises displaying the first and second monitored flight vehicles in a visually distinguishable manner from the other monitored flight vehicles and displaying operation information of the first monitored flight vehicle and operation of the second monitored flight vehicle around the first and second monitored flight vehicles, respectively.

8. The method of claim 4, wherein the displaying the details on how to control the first and second monitored flight vehicles, comprises displaying the neighboring virtual flight vehicles of the first monitored flight vehicle and the neighboring virtual flight vehicles of the second monitored flight vehicle and displaying guidelines for avoiding the potential collision between the first and second monitored flight vehicles.

9. The method of claim 8, wherein the displaying the guidelines for avoiding the potential collision between the first and second monitored flight vehicles, comprises displaying guidelines for deviating the first monitored flight vehicle from a predefined flight path of the first monitored flight vehicle.

10. The method of claim 8, wherein the displaying the guidelines for avoiding the potential collision between the first and second monitored flight vehicles, comprises displaying guidelines for deviating the second monitored flight vehicle from a predefined flight path of the second monitored flight vehicle.

11. The method of claim 8, wherein the displaying the guidelines for avoiding the potential collision between the first and second monitored flight vehicles, further comprises avoiding the potential collision between the first and second monitored flight vehicles by automatically selecting one of the guidelines if no user input is received for a predefined amount of time after the displaying the guidelines for avoiding the potential collision between the first and second monitored flight vehicles.

12. A system for controlling the operations of flight vehicles, comprising:
a processor; and
a memory storing instructions;
wherein when executed by the processor, the instructions allow the processor to perform operations of: assigning neighboring virtual flight vehicles to each of monitored flight vehicles; inputting operation information of the monitored flight vehicles to a collision detection model; and if information indicating that a collision has occurred between neighboring virtual flight vehicles of the first monitored flight vehicle and neighboring virtual flight vehicles of the second monitored flight vehicle is output from the collision detection model, outputting a collision warning message, and
the collision detection model is a model that utilizes operation information of the neighboring virtual flight vehicles, which is obtained by applying the operation information of the monitored flight vehicles to their respective neighboring virtual flight vehicles, to determine and output the occurrence of a collision between the neighboring virtual flight vehicles of the first and second monitored flight vehicles.

13. The system of claim 12, wherein the operation of assigning the neighboring virtual flight vehicles to each of the monitored flight vehicles comprises providing a first control screen that displays the operation information of the monitored flight vehicles and providing a second control screen that displays operation information of neighboring virtual flight vehicles of the second monitored flight vehicle, obtained using a camera installed in the first monitored flight vehicle.

14. The system of claim 12, wherein the neighboring virtual flight vehicles have the same shape and specifications as their respective monitored flight vehicles.

15. The system of claim 12, wherein the operation of outputting the collision warning message comprises predicting a potential collision between the first and second monitored flight vehicles, displaying context information of the potential collision on the first control screen if the potential collision is predicted, and displaying details on how to control the first and second monitored flight vehicles to avoid the potential collision on the first control screen.

16. The system of claim 15, wherein the operation of predicting the potential collision between the first and second monitored flight vehicles comprises predicting that a collision between the first and second monitored flight vehicles will occur when a collision between one of the neighboring virtual flight vehicles of the first monitored flight vehicle and one of the neighboring virtual flight vehicles of the second monitored flight vehicle occurs.

17. The system of claim 15, wherein the operation of displaying the details on how to control the first and second monitored flight vehicles comprises displaying the neighboring virtual flight vehicles of the first monitored flight vehicle and the neighboring virtual flight vehicles of the second monitored flight vehicle and displaying guidelines for avoiding the potential collision between the first and second monitored flight vehicles.

18. The system of claim 17, wherein the operation of displaying the guidelines for avoiding the potential collision between the first and second monitored flight vehicles comprises displaying guidelines for deviating the first monitored flight vehicle from a predefined flight path of the first monitored flight vehicle.

19. The system of claim 17, wherein the operation of displaying the guidelines for avoiding the potential collision between the first and second monitored flight vehicles comprises displaying guidelines for deviating the second monitored flight vehicle from a predefined flight path of the second monitored flight vehicle.

20. The system of claim 17, wherein the operation of displaying the guidelines for avoiding the potential collision between the first and second monitored flight vehicles further comprises avoiding the potential collision between the first and second monitored flight vehicles by automatically selecting one of the guidelines if no user input is received for a predefined amount of time after the displaying the guidelines for avoiding the potential collision between the first and second monitored flight vehicles.
